(19) United States
(12) Patent Application Publication
(10) Pub. No.: US 2019/0084684 A1
(43) Pub. Date: Mar. 21, 2019

(54) HYBRID AIRCRAFT

(71) Applicant: SIKORSKY AIRCRAFT CORPORATION, Stratford, CT (US)

(72) Inventor: EREZ ELLER, Oakville, CT (US)

(21) Appl. No.: 15/710,645

(22) Filed: Sep. 20, 2017

(51) Int. Cl. B64D 27/24; B64C 29/00; B64C 27/22; B64C 11/30; G05D 1/08

(52) U.S. Cl. CPC B64D 27/24; B64C 29/0025; B64D 2027/026; B64C 11/30; G05D 1/0808; B64C 27/22

(57) ABSTRACT

An aircraft can include an electrical energy system including at least one battery having a plurality of cells, at least one fuel tank, one or more electrical motors powered by the electrical energy system and configured to drive one or more rotors for providing vertical thrust, and at least one fluid fueled engine operatively connected to the at least one fuel tank to drive a thruster for forward propulsive force.

### BACKGROUND

### 1. Field

The present disclosure relates to aircraft, more specifically to hybrid powered aircraft.

### 2. Description of Related Art

High speed Vertical Takeoff or Landing (VTOL) vehicles tend to be mechanically complex due to aircraft control required and physical reconfiguration that occurs across the speed envelope, negatively affecting many design attributes. They are also generally inefficient in parts of the speed envelope due to tradeoffs that have to be made between cruise and hover efficiency, based on propulsion system configuration (e.g. tilt-rotor or compound helicopter driven by combustion engine).

Electrically powered multirotor aircraft (e.g., a quadcopter) are mechanically simple, but have poor cruise efficiency and low flight time due to low battery energy density. Such aircraft also need to fly with significant nose down pitch attitude since the rotors are immovable which ultimately limits airspeed. Although tilting the rotors offers increase in speed, it comes at the expense of mechanical complexity due to the mechanism required, but also additional mechanisms required for high speed aircraft control (e.g. ailerons, elevator, and rudder).

Such conventional methods and systems have generally been considered satisfactory for their intended purpose. However, there is still a need in the art for improved aircraft systems. The present disclosure provides a solution for this need.

### SUMMARY

In accordance with at least one aspect of this disclosure, an aircraft can include an electrical energy system including at least one battery having a plurality of cells, at least one fuel tank, one or more electrical motors powered by the electrical energy system and configured to drive one or more rotors for providing vertical thrust, and at least one fluid fueled engine operatively connected to the at least one fuel tank to drive a thruster (e.g., a propeller or fan) for forward propulsive force.

The aircraft can include a generator operatively connected to the at least one fueled engine and configured to charge the at least one battery and/or power the electric motors. Rotors are operatively connected to the motors to provide lift. The aircraft can include an electric starter operatively connected to the electrical energy system for starting the fueled engine. In certain embodiments, the generator and the starter can be the same device (e.g. A starter-generator).

The thruster can be operatively connected to the fluid fueled engine (e.g., directly or through speed reduction, e.g. belt drive or gearbox), wherein the thruster includes at least one of a propeller or a ducted fan. A clutch may be configured to engage and disengage the thruster. In certain embodiments, the aircraft can include a blade pitch control mechanism configured to modify a pitch of the thruster, to change the amount of thrust produced.

The electrical energy system can include a controller (e.g., a Power Control Module (PCM)) configured to control the speed of the one or more electric motors through electrical switching to consume electrical power (driving torque) or produce electrical power (braking torque) at each motor, and manage power conversion between the motors and energy sources and sinks. The electrical energy system can also include a Battery Management System (BMS).

A braking torque can be applied by dynamic braking where kinetic rotational energy of the rotor is converted into heat in the electric motor, or by regenerative braking where the kinetic energy is converted into electrical energy and sent back to the PCM from which it can be sent to other motors or back to the battery. In certain embodiments, each rotor is driven by a plurality of electric motors or motors with redundant coil sets. In certain embodiments, the aircraft can include three or more rotors driven by the one or more electric motors (e.g., one or more motors per rotor).

The aircraft can include one or more tilting wings operatively connected to an airframe of the aircraft and configured to reduce rotor induced downward drag in a vertical take-off and landing (VTOL) regime and provide lift as a function of airspeed in a forward flight regime. The one or more tilting wings can be attached to a structure that attaches the electric motors to the airframe, wherein the one or more tilting wings rotate about the span-wise axis.

The one or more wings can passively rotate due to airflow. The one or more wings can be configured to rotate manually or automatically to improve flight efficiency or aircraft controllability.

In accordance with at least one aspect of this disclosure, an aircraft can include an electrically powered vertical lifting means and a liquid fuel powered forward propulsion means. The aircraft can include one or more tilting wings configured to reduce rotor induced downward drag in a vertical take-off and landing (VTOL) regime and provide lift as a function of airspeed in a forward flight regime. In certain embodiments, the aircraft can include an electrical energy system comprising multiple cells within a Battery Management System, at least one fuel tank, four or more fixed pitch rotors driven by electrical motors powered by a Power Control Module and configured for providing vertical thrust, at least one fueled engine operatively connected to the at least one fuel tank, and at least one thruster (e.g., propeller or ducted fan) for forward propulsive force.

In accordance with at least one aspect of this disclosure, a method includes producing horizontal thrust with a fueled engine, producing vertical thrust with an electrical motor, determining whether one or more wings of an aircraft is producing sufficient lift due to airspeed, and reducing and/or eliminating power to an electric lifting motor if it is determined that sufficient lift is being generated. The method can include stabilizing and controlling the aircraft by changing each rotor speed for climb rate, pitch, roll, and yaw control.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic plan view of an embodiment of an aircraft in accordance with this disclosure;

FIG. 2 is a schematic elevation of an embodiment of an aircraft in accordance with this disclosure;

FIG. 3 is a plan view of the embodiment of FIG. 2; and

FIGS. 4a-4c are diagrams of embodiments of free-wing airfoils in accordance with this disclosure.

### DETAILED DESCRIPTION

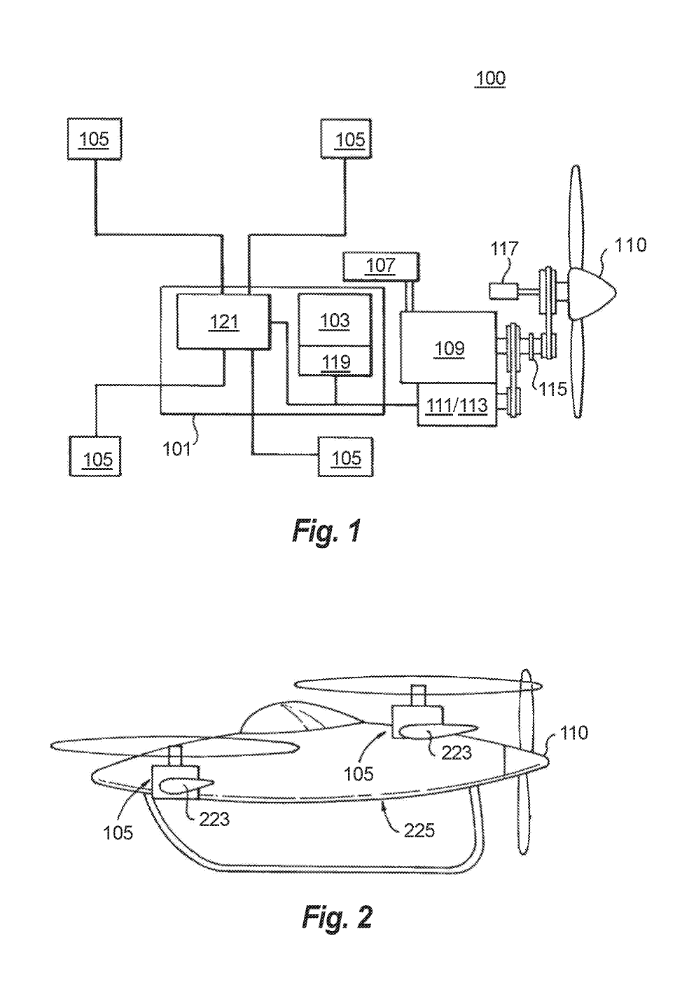

Reference will now be made to the drawings wherein like reference numerals identify similar structural features or aspects of the subject disclosure. For purposes of explanation and illustration, and not limitation, an illustrative view of an embodiment of an aircraft in accordance with the disclosure is shown in FIG. 1 and is designated generally by reference character 100. Other embodiments and/or aspects of this disclosure are shown in FIGS. 2-4c. The systems and methods described herein can be used to provide more efficient aircraft.

In accordance with at least one aspect of this disclosure, referring to FIG. 1, an aircraft 100 includes an electrical energy system 101 comprising at least one battery 103 (e.g., which has a plurality of battery cells). The aircraft 100 also includes one or more electrical motors 105 per rotor powered by the electrical energy system 101 and configured to drive one or more rotors (e.g., three or more, such as four) for providing vertical thrust to the aircraft 100. For example, an aircraft can include a single rotor (or a plurality of coaxial rotors) such as a traditional helicopter (e.g., an X2) that is electrically powered via one or more electric motors 105 and a fluid fueled engine to powers a thruster.

The aircraft 100 also includes at least one fuel tank 107 and at least one fueled engine 109 operatively connected to the at least one fuel tank 107 and configured to drive at least one thruster, e.g., for forward propulsion. The aircraft 100 can include a generator 111 operatively connected to the at least one fueled engine 109 and configured to charge the at least one battery 103 and/or provide electrical power directly to the motors 105.

The aircraft 100 can include an electric starter 113 operatively connected to the electrical energy system 101 for starting the fueled engine 109. In certain embodiments, the generator 111 and the starter 113 can be a single unit such that the aircraft can include a starter-generator operatively connected to the at least one fueled engine and configured to charge the at least one battery and to start the fueled engine using battery 103 energy. The starter-generator may have a speed reduction, or be directly driven off the engine.

The mode of propulsion for the fueled engine 109 can be any suitable mode powered by fluid or solid fuel (e.g., a turbomachine with or without a fan or propeller, a reciprocating engine with a propeller, a rocket). In certain embodiments, the aircraft 100 can include a propeller 110 operatively connected to the at least one fueled engine 109.

In certain embodiments, the aircraft 100 can include a clutch and/or brake 115 configured to engage and disengage the thruster 110 to/from the fueled engine 109. The clutch and/or brake 115 can control the amount of power going to the thruster 110 or the generator 111 in certain embodiments or stop rotation of the thruster. The aircraft 100 can include a thruster pitch 117 control configured to modify a pitch of the thruster 110.

The electrical energy system 101 can include a Battery Management System (BMS) 119. The BMS can monitor the state of individual cells, protect them from operating outside the Safe Operating Area of the cells, calculate and report secondary data, control temperature, and/or balance the state of charge of the cells.

The electrical energy system 101 can include a controller 121 for controlling a speed of the one or more electric motors 105. The controller 121 can include any suitable hardware and/or software to control the speed of the electric motors 105 in a forward or reverse direction and forward or reverse torque by sending or receiving electrical energy from the electric motors 105. For example, the controller 105 can include any suitable power electronics. In certain embodiments, the controller 121 can be a Power Control Module (PCM) that can be used to manage electrical power flow and conversion throughout the vehicle. The PCM can provide power from the battery 103 to the starter 113 (for engine starting), and/or receive power from the generator 111 to charge the battery 103 and/or to power the electrical motors 105, and/or control each motor's rotational speed by sending or regenerating power. Electrical power can flow between motors 105 and/or collectively to/from the battery 103 and/or starter-generator 111/113. The PCM may be within a single enclosure, or may be distributed in multiple locations throughout the aircraft to reduce failure hazards and reduce electromagnetic interference. The controller 121 and/or the BMS 119 can be integrated with and/or controlled by an aircraft flight control module.

In certain embodiments, the one or more electric motors 105 can include a plurality of electric motors 105. The plurality of electric motors 105 can include three or more rotors (e.g., four rotors) driven by the electric motors, for example. Each electric motor 105 can be disposed to have thrust in the same direction or in any other suitable manner. In certain embodiments, the three (e.g., four as shown) or more rotors may each have a plurality of electric motors 105 or more than three phases per motor for redundancy.

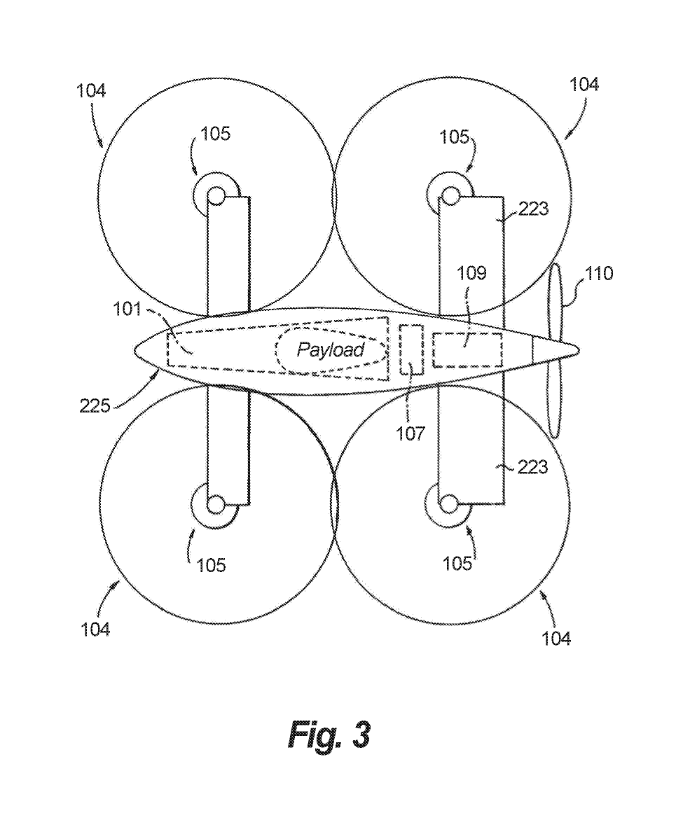

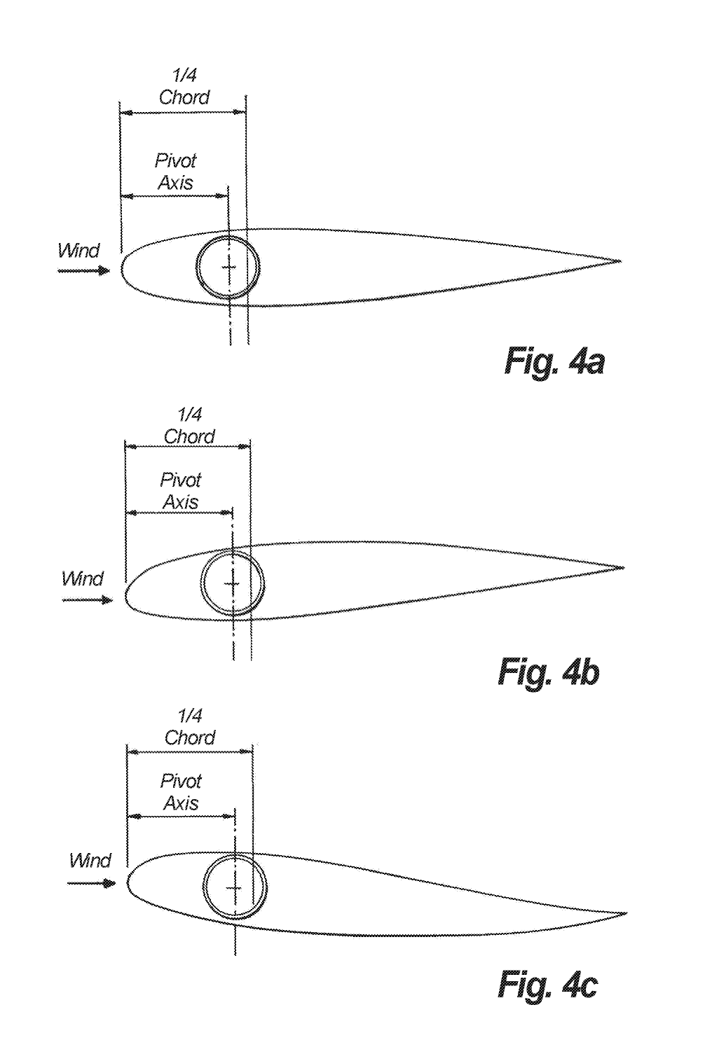

Referring additionally to FIGS. 2 and 3, in certain embodiments, the aircraft 100 can include one or more wings 223 operatively connected to an airframe 225 of the aircraft 100 and configured to provide lift as a function of airspeed. The one or more wings 223 can be movable between a lift producing position and a vertical position. For example, the one or more wings 223 can include a free wing (a passively tilting wing) configured to rotate vertically in a vertical take-off and landing (VTOL) regime and to produce lift in forward flight. Referring additionally to FIGS. 4a-4c, the one or more wings 223 can include any suitable airfoil (e.g., a cambered reflexed wing, for example).

The wings 223 can be operatively connected to a structure between each motor and the airframe of the aircraft 100 and configured to reduce vertical drag on the structure in hover and forward flight by using symmetric airfoil family 4a. Airfoil family 4b (cambered) and 4c (cambered reflexed) could be used to provide lift as a function of airspeed. For example, the one or more wings 223 can be configured to passively weathervane, rotating leading edge up in a vertical take-off and landing (VTOL) regime and rotate nearly horizontally to produce lift in a forward flight regime, for example with airfoil 4c.

In certain embodiments, the one or more wings 223 are selectively moveable by a user of the aircraft 100. The one or more wings 223 can be controlled manually by the pilot or by any suitable controller (e.g., the controller 121 or an aircraft controller). The wing 223 characteristics can be selected based on location of pivot point of free wing e.g., a cambered reflexed airfoil with a hinge point forward of quarter cord counteracts airfoil pitching moment. The wings 223 can be used as control surface in certain embodiments, e.g., for controlling one or more of roll or pitch.

The one or more electrical motors 105 can be used as generators in a descent or air brake regime. In certain embodiments, the controller 121 can be configured to reduce electric motor speed and/or shut off electric motor speed at a threshold airspeed where lift produced by the one or more wings 223 is sufficient to lift the aircraft 100.

As appreciated by those having ordinary skill in the art, the aircraft can be configured to include any suitable blade geometry (e.g., such as that described in U.S. Pat. No. 7,252,479 incorporated herein by reference). Integration of one or more electrical motors with one or more fluid fueled propulsions system and/or the motor fairing can be done in any suitable manner (e.g., similar to embodiments of fairings as described in U.S. Pat. No. 7,229,251 incorporated herein by reference).

Any suitable flight control scheme is contemplated herein. For example, embodiments can include a traditional multirotor control system that varies RPM of the motors for pitch, roll, yaw and vertical thrust, but with addition of forward propulsion. Embodiments can include suitable redundancy features (e.g., multiple flight control computers and IMUs).

In certain embodiments, in an engine out mode the battery can still be used as a buffer to operate (e.g., by powering the motors 105) and/or land the aircraft. In a battery out condition, the fluid fueled engine can act as a buffer to produce electrical power for the motors 105.

In accordance with at least one aspect of this disclosure, a method can include producing horizontal thrust with a fueled engine, producing vertical thrust with an electrical motor, determining whether one or more wings of an aircraft is producing sufficient lift due to airspeed, and reducing and/or eliminating power to an electric lifting motor if it is determined that sufficient lift is being generated.

A command can be sent from pilot or autonomous controls to one or more flight control computers (FCC) and the one or more FCC then sends motor speed commands to a Power Control Module (PCM). The method can include stabilizing and controlling the aircraft by changing each rotor speed, forward or reverse, for climb rate, pitch, roll, and yaw control.

Battery state of charge can be managed. For example after climb out, the battery may be depleted to a certain threshold. Until the battery is charge up, majority of engine power may be diverted to charging the battery until the upper charge threshold is reached. Until that happens, forward speed and climb rate can be limited, for example.

The method can include converting a pilot or autonomous speed command and optimizing engine and thruster RPM and pitch for best cruise efficiency as a function of velocity by the FCC. Embodiments can utilize an X2 rotor configuration, e.g., as described in U.S. Pat. No. 7,252,479, incorporated herein by reference. X2 style rotor fairings can also be used in certain embodiments.

Aircraft pitch attitude and rotor RPM can be optimized for best cruise efficiency as a function of velocity by the FCC in certain embodiments. Embodiments can include fuel and charging ports.

The method can include gauging total range and electric only range, which can be useful for emergency landing planning and noise and emissions sensitive landing planning for example. The aircraft may be optionally piloted and/or utilize one or more matrix algorithms in piloting the aircraft.

As appreciated by those having skill in the art in view of this disclosure, a multirotor can simplify aircraft mechanics because only motor speed of rotors is needed for full control. Embodiments include a multirotor design with a forward flight propeller driven by a liquid fuel engine (e.g., jet or piston) which eliminates losses from power conversion to electric and back to mechanical in existing hybrid technology. Moreover, embodiments include electric rotors which can be used as generators in a glide scenario.

Embodiments include a free wing which can point up in hover to reduce drag from downwash from rotors 104 (e.g., where wings are positioned under the rotors 104) and, in cruise, can move to horizontal to produce lift, e.g., as desired. Embodiments include at least one way of turning thrust off at low airspeed while the engine is running (e.g., thruster pitch control 117, clutch 115). In certain embodiments, the electric motors 105 could be used to produce power and lift (e.g., in a nose up attitude using autorotation) or to consume power for lift.

Embodiments include four rotors driven by electric motors with redundant coils with four quadrant motor control for vehicle control. Such embodiments include an auxiliary propeller attached to a fueled engine (e.g., turbomachine, piston engine, rocket) that also drives starter/generator. Embodiments can include a battery buffer in the event of engine failure. The variable pitch of the propeller can increase with speed. Embodiments include free-wing fairings and/or control surfaces for high speed. In use, lift rotor power can be reduced with speed and most power can be directed to the propeller.

Embodiments as disclosed above increase flight efficiency compared to converting mechanical energy to electrical energy and back which incurs at about 20% losses in conversion (e.g. from engine 109 to generator 111, to DC power, to PCM 121, to motor 105). Embodiments include a low parts count compared to a traditional helicopter (e.g., no transmission/controls) and include high speed capability. Certain advantages of embodiments of a vehicle including efficiency, simplicity and range, along with full VTOL capability.

By way of example, aspects of the invention can be used in coaxial helicopters, on tail rotors, or wings or propeller blades on fixed or tilt wing aircraft.

As will be appreciated by those skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

The methods and systems of the present disclosure, as described above and shown in the drawings, provide for aircraft with superior properties including. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. An aircraft, comprising:
an electrical energy system including at least one battery having a plurality of cells;
at least one fuel tank;
one or more electrical motors powered by the electrical energy system and configured to drive one or more rotors for providing vertical thrust; and
at least one fluid fueled engine operatively connected to the at least one fuel tank to drive a thruster for forward propulsive force.

2. The aircraft of claim 1, further comprising a generator operatively connected to the at least one fueled engine and configured to charge the at least one battery and/or power the lift motors.

3. The aircraft of claim 2, further comprising an electric starter operatively connected to the electrical energy system for starting the fueled engine.

4. The aircraft of claim 2, further comprising the thruster operatively connected to the fluid fueled engine, wherein the thruster includes at least one of a propeller or a ducted fan.

5. The aircraft of claim 4, further comprising a clutch configured to engage and disengage the thruster.

6. The aircraft of claim 4, further comprising a blade pitch control mechanism configured to modify a pitch of the thruster, to change the amount of thrust produced.

7. The aircraft of claim 1, wherein the electrical energy system includes a Power Control Module (PCM) configured to control the speed of the one or more electric motors by applying a driving or a braking torque, and/or applying the power conversion required by the motor configuration in either direction of rotation.

8. The aircraft of claim 7, wherein the electrical energy system includes a Battery Management System (BMS).

9. The aircraft of claim 7, wherein braking torque can be applied by dynamic braking where kinetic rotational energy of the rotor is converted into heat in the electric motor, or by regenerative braking where the kinetic energy is converted into electrical energy and sent back to the PCM from which it can be sent to other motors or back to the battery.

10. The aircraft of claim 1, wherein each rotor is driven by a plurality of electric motors or motors with redundant coil sets.

11. The aircraft of claim 1, wherein the aircraft includes three or more rotors driven by the one or more electric motors.

12. The aircraft of claim 1, further comprising one or more tilting wings operatively connected to an airframe of the aircraft and configured to reduce rotor induced downward drag in a vertical take-off and landing (VTOL) regime and provide lift as a function of airspeed in a forward flight regime.

13. The aircraft of claim 12, wherein the one or more tilting wings are attached to a structure that attaches the electric motors to the airframe, wherein the one or more tilting wings rotate about the span-wise axis.

14. The aircraft of claim 12, wherein the one or more wings passively rotate due to airflow.

15. The aircraft of claim 13, wherein the one or more wings are configured to rotate manually or automatically to improve flight efficiency or aircraft controllability.

16. An aircraft, comprising:
an electrically powered vertical lifting means; and
a liquid fuel powered forward propulsion means.

17. The aircraft of claim 16, further comprising one or more tilting wings configured to reduce rotor induced downward drag in a vertical take-off and landing (VTOL) regime and provide lift as a function of airspeed in a forward flight regime.

18. The aircraft of claim 16, further comprising:
an electrical energy system comprising multiple cells within a Battery Management System;
at least one fuel tank;
four or more fixed pitch rotors driven by electrical motors powered by a Power Control Module, and configured for providing vertical thrust;
at least one fueled engine operatively connected to the at least one fuel tank; and at least one thruster (propeller or ducted fan) for forward propulsive force.

19. A method, comprising:
producing horizontal thrust with a fueled engine;
producing vertical thrust with an electrical motor;
determining whether one or more wings of an aircraft is producing sufficient lift due to airspeed; and
reducing and/or eliminating power to an electric lifting motor if it is determined that sufficient lift is being generated.

20. The method of claim 17, further comprising stabilizing and controlling the aircraft by changing each rotor speed for climb rate, pitch, roll, and yaw control.
